(19) United States
(12) Patent Application Publication
(10) Pub. No.: US 2011/0295961 A1
(43) Pub. Date: Dec. 1, 2011

(54) SYSTEM AND METHOD FOR CONVEYING PATIENT INFORMATION

(75) Inventors: Tom Wilkes, Seattle, WA (US); Steve Hall, Edmonds, WA (US); Kent Hargrave, Edmonds, WA (US)

(73) Assignee: M2 INFORMATION SYSTMS, INC., Edmonds, WA (US)

(21) Appl. No.: 13/096,818

(22) Filed: Apr. 28, 2011

Related U.S. Application Data
(60) Provisional application No. 61/329,045, filed on Apr. 28, 2010.

(51) Int. Cl. G06F 15/16

(52) U.S. Cl. 709/206

(57) ABSTRACT

A system for conveying patient information is configured to receive data related to a patient, and convert the data into event-driven messages for transmission to communication devices carried by physicians and others.

### CROSS-REFERENCE TO RELATED APPLICATIONS

The present application claims priority benefit from, and to the extent not inconsistent with the disclosure herein, incorporates by reference U.S. Provisional Patent Application Ser. No. 61/329,045; invented by Tom Wilkes, Steve Hall, and Kent Hargrave; entitled SYSTEM AND METHOD FOR CONVEYING EVENT-DRIVEN PATIENT INFORMATION, filed Apr. 28, 2010; which is co-pending at the date of this filing.

### BACKGROUND

Delivering efficient and effective treatment to patients frequently requires clear and rapid communication between one or more physicians, nurses, hospital admissions personnel, pharmacy, and one or more diagnostic test facilities. A primary vehicle for accumulating and maintaining records and for communication is the patient record. In today's hospitals and other care environments, patient records are frequently maintained in one or more computer databases.

Typically, computer databases are organized along the lines of traditional paper patient records. Unfortunately, this does not inherently provide patient information on an event-driven basis. That is, a physician or other caregiver must open the patient record to see events such as admissions, physician's orders, laboratory results, etc. relevant to the patient. This may result in delays of information dissemination, potentially missed entries, and relatively significant effort.

What is needed is a system and method for providing access to patient information responsive to events. Moreover, what is needed is a system and method for providing event-driven patient information using a communication medium that is convenient and allows physicians and others to receive the patient information in mobile environments.

### SUMMARY

According to an embodiment, a system for conveying patient information includes a data interface configured to receive first data messages including patient information, a data-aware interface engine operatively coupled to the data interface and configured to extract the patient information from the first data messages, and a message server operatively coupled to the data-aware interface engine and configured to selectively output messages carrying at least a portion of the patient information or an indication of the patient information to a plurality of communication devices. The data-aware interface engine may be configured to select messages for output as a function of urgency or importance of the patient information. The data-aware interface engine may be configured to convert the patient information to second data. The second data may be saved in a database for retrieval by the message server. The message server may perform queries to assemble messages for output. The message server may access subscriber preferences and patient records to determine a subscriber distribution for a message. A web server operatively coupled to the message server may be configured to output the messages output by the message server for presentation by browser interfaces in the plurality of communication devices. The message server and the web server may be configured to cooperate with the database to respond to requests from the communication devices to provide detailed or drill-down data related to the patient information or the indication of the patient information.

According to another embodiment, a method for conveying patient information includes receiving, with a network data interface, a first data message including patient information; determining, with a computer processor, an importance or urgency corresponding to the patient information in the first data message; determining, with the computer processor, a subscriber distribution corresponding to the patient information in the first data message; and transmitting one or more second data messages corresponding to the first data message to one or more communication devices corresponding to the subscriber distribution.

According to another embodiment, a computer-readable medium carries computer executable instructions configured to cause a computer to execute the steps of receiving, with a network data interface, a first data message including patient information; determining, with a computer processor, an importance or urgency corresponding to the patient information in the first data message; determining, with the computer processor, a subscriber distribution corresponding to the patient information in the first data message; and transmitting one or more second data messages corresponding to the first data message to one or more communication devices corresponding to the subscriber distribution.

### BRIEF DESCRIPTION OF THE DRAWINGS

FIG. 1 is a block diagram of a system for conveying patient information to subscriber communication devices, according to an embodiment.

FIG. 2 is a depiction of a data structure by which patient information is organized in a database, according to an embodiment.

FIG. 3 is a depiction of a message display showing event-driven patient-related messages on a communication device, according to an embodiment.

FIG. 4 is a depiction of a communication device drill-down display showing a grid display of historical data, according to an embodiment.

FIG. 5 is a depiction of a communication device drill-down display showing a lab result detail, according to an embodiment.

FIG. 6 is a depiction of a communication device drill-down display showing a progress note ready for approval, according to an embodiment.

FIG. 7 is a flow chart showing a method for transmitting patient information to communication devices of subscribers, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

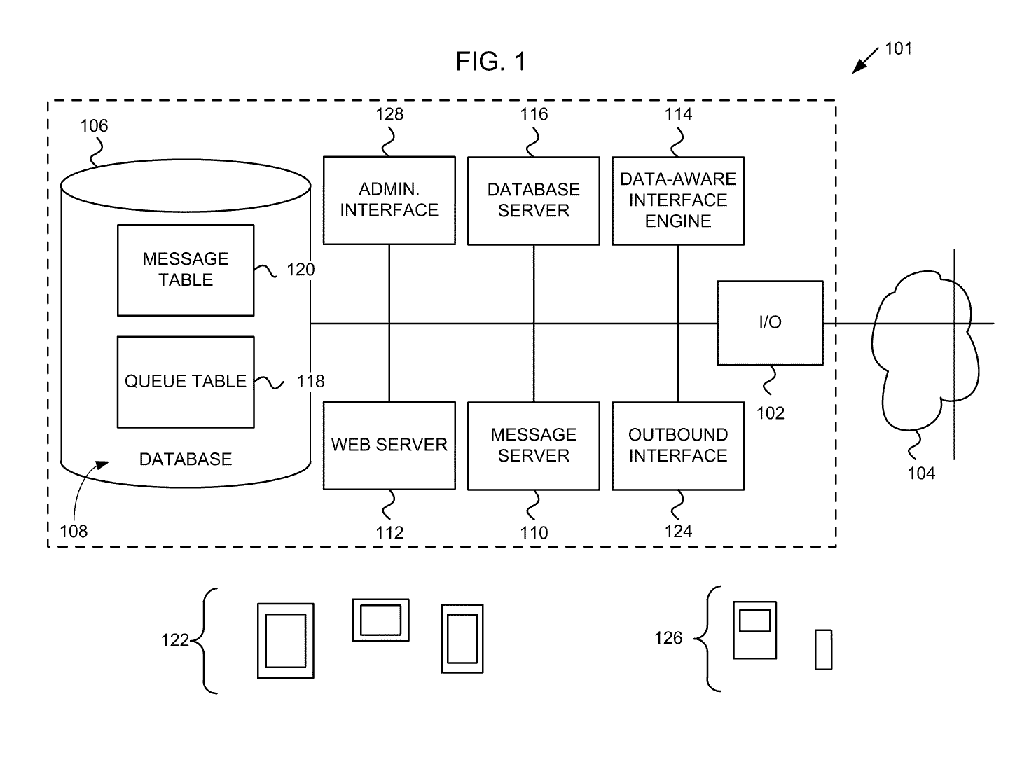

FIG. 1 is a block diagram of a system 101 for conveying patient information, according to an embodiment. The system 101 includes a data interface 102 configured to receive first data including patient information from a plurality of sources. For example, the plurality of patient information data sources may be operatively coupled to the data interface 102 via a network 104 such as a LAN, WAN, and/or the Internet. The patient information included in the first data messages (and indicated or included in second data messages described below) may include admission information, patient consents, physicians' orders, physicians' progress notes, physicians' comments, laboratory results, pharmacy medication logs, nursing notes, nursing assessments, nursing care plans, respiratory therapy progress notes, dietary notes, and/or nurses' station messages.

In a typical hospital and/or other healthcare or nursing environments, instances of generating such data may be viewed as events. Each event typically has corresponding data received by the interface 102, a corresponding time, and an importance or urgency. The first data may include and be received as a series of Health Level Seven (HL7) messages. As used herein, an HL7 message may be a message having syntax corresponding to HL7 v2.x, v3.0, or other subsequent releases of healthcare informatics interoperability standards. HL7 data communications standards, typically released by HL7, Inc. working groups and recognized by ANSI and ISO, aim to promote standardized protocols that enable interoperability of healthcare information systems, across multiple vendors.

A data-aware interface engine 114 may monitor the data interface 102 for first data messages that include patient information, and extract the patient information from the first data messages. The data-aware interface engine 114 may then determine the importance or urgency of the patient information in the first data messages using approaches described below. The data-aware interface engine 114 then outputs the patient information and corresponding importance information as second data in a database 108 on one or more computer storage devices 106. To encode the importance of an instance of patient information received in the first data messages, the data-aware interface engine 114 may populate the database 108 with trigger fields associated with the patient information fields. As is described below, the trigger fields will drive a database server 116 to queue the patient information for second data message assembly and transmission. The data-aware interface engine 114 may be configured as a server including dedicated hardware, or as a software module configured to run on the same computer processor as at least a portion of the other components shown in the system 101 of FIG. 1.

The database 108 may include one or may include a plurality of databases. In an embodiment, the database 108 includes a SQL database. The second data may include data that is formatted in a way that is consistent with the first data received by the interface 102. Accordingly, in some applications, at least a portion of the second data may be the same as a portion of the first data. The first data received by the interface 102 may alternatively or additionally include data that is formatted in a way that is not the same as the format of data in the database 108.

One or more computer storage devices 106 carry the database 108 configured to hold second data including at least a portion of the patient information included in the first data. A database server 116 responds to the trigger fields loaded by the data-aware interface engine 114 into database 108 records including the patient information by including the triggered records in a queue table 108. This approach can help ensure that during periods of high data traffic, the most important or urgent information is attended to first. The database server 116 may be configured as a server including dedicated hardware, or as a software module configured to run on the same computer processor as at least a portion of the other components shown in the system 101 of FIG. 1. For example, the database server 116 may be a Structured Query Language (SQL) server available from Microsoft® or Sybase®.

A message server 110 may be configured to receive at least a portion of the second data from the database 108, for example, by reading the queue table 118. The message server 110 then assembles second data messages for output. For example, the message server 110 may typically formulate one or more queries that may be handled by the database server 116 and/or by other services. One type of query that may be formulated by the message server 110 is used to determine a subscriber distribution for each second data message. For example, the message server 110 may read a patient identity in the second data from the queue table 118, and query the corresponding patient record in the database 108 to determine subscriber identities or addresses associated with the patient. The message server 110 may also query a subscriber preference table (not shown) to determine under what conditions each subscriber should receive a second data message (for example, as a function of subject matter, importance, and/or urgency), which of several particular subscribers should be addressed (for example, as a function of on-call schedule), and preferred modes of communication (explained more fully below). The message server 110 may similarly formulate queries to retrieve phraseology or at least portions of message content or format responsive to the patient information. Queries run by the message server 110 may include XML Path Language (XPath) queries queries. The message server 110 may convert the data to a format appropriate for output, for example, to XML. The message server 110 may then load the second data message, including associated or embedded subscriber distribution, into a message table 120.

The message server 110 may include dedicated hardware or may be configured as a software module configured to be run on the same computer processor (not shown) as at least a portion of the other components shown in the system 101 of FIG. 1.

A web server 112 may be configured to read messages from the message table 120 and output the messages to browser-enabled communication devices 122. The web server 112 may include dedicated hardware or may be configured as a software module configured to be run on the same computer processor (not shown) as at least a portion of the other components shown in the system 101 of FIG. 1. The web server 112 may include an Internet Information Services server, available from Microsoft®, and/or may include another server capable of providing viewing of web pages.

The second data messages output by the message server 110 and displayed by the web server 112 may typically be event-driven messages. According to embodiments, the second data messages may be displayed in near real-time corresponding to the time of data generation (such as within seconds or minutes of the event), and may be displayed in a way indicative of the importance or urgency of the corresponding events.

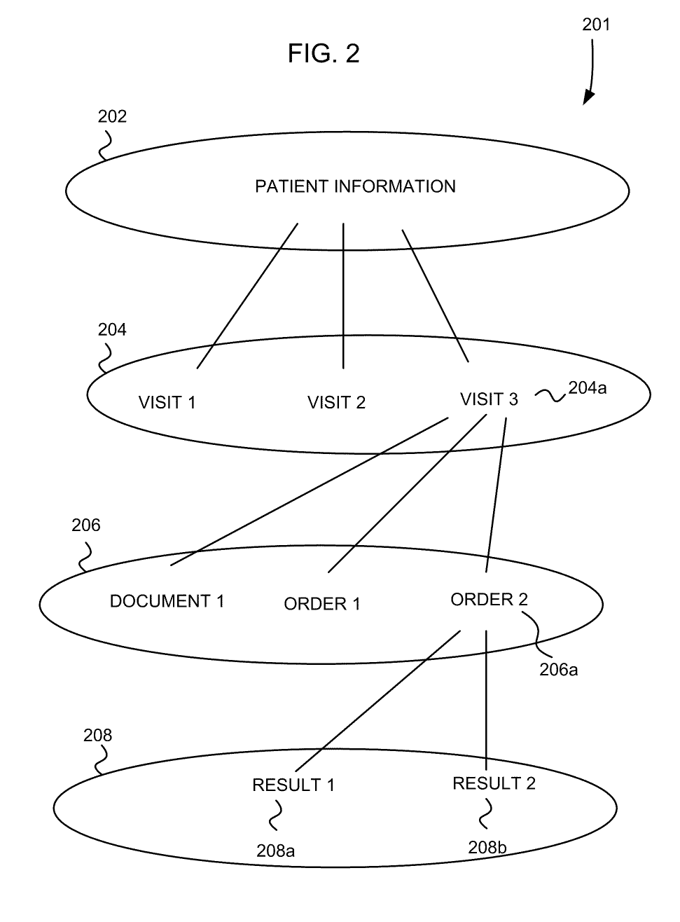

FIG. 2 is a depiction of a data structure 201 by which patient information may be organized in the database 108, according to an embodiment. The second data in the database 108 may typically be organized in a tree structure 201, as illustrated. The tree structure 201 may include a patient level 202, a visit level 204, an orders and documents level 206, and a results level 208. Events may occur at any of the visit, orders and documents, and results levels 204, 206, and 208. Physician or other caregiver preferences may be associated with any of the levels. For example, a given visit 204a may have associated with it an admitting physician identification, an attending physician identification, and a personal physician identification. Similarly, a given order 206a on the orders and documents level 206 may have associated with it an ordering physician identification.

As indicated above, each of the admitting physician, attending physician, personal physician, and ordering physician may register preferences with respect to notification, mode of notification, shift, backup, and/or urgency. This set of preferences, combined with the patient identity, practice area, and urgency or importance of a message (which, as described below, may be extracted from the HL7 or first data message by the data-aware interface engine), may be used to determine a set of selected subscribers for each message. For example, for a given result event 208a which is delivered as a normal priority result, the ordering physician and personal physician may indicate a desire for notification, but with the personal physician indicating a preference for partner notification if the result is delivered while not on-call. Referring to FIG. 1, this may result in a set of selected subscribers corresponding to the ordering physician and an on-call partner of the personal physician, which then drives the system to notify the ordering physician and the on-call partner of the personal physician of the normal priority result 208a. The ordering physician may register a preference for receiving notification via a message served by the web server 112, and the on-call partner may register a preference for being paged (as described below). Accordingly, each physician will receive a message associated with the normal priority result 208a via his/her preferred mode.

Alternatively, another result 208b may be determined by the data-aware interface engine 114 (described below) to be an out-of-range result that is urgent. If the attending physician, the personal physician, and the ordering physician each indicate a preference to receive a message indicative of the urgent response via the web server 112, then each of the attending, personal, and ordering physicians will receive a corresponding message via the web server. Each of the attending, personal, and/or ordering physicians will receive the message very soon if he/she is logged in. Otherwise, each selected subscriber will receive the message the next time he/she logs in.

Referring again to FIG. 1, the data-aware interface engine 114 may be operable to read data in the received messages and determine urgency or importance of the patient information in the first data messages, and save corresponding second data that includes an indication of the urgency or critical nature of the received message. For example, the data-aware interface engine 114 may be configured to insert trigger data indicative of urgency into the second data when corresponding first data includes patient information that is time-sensitive. The data-aware interface engine 114 may similarly insert other trigger data indicating non-urgency, or omit trigger data from the second data. Trigger data is inserted into a trigger field defined in records of the database 108. For received first data that does not include a trigger field or includes a differently defined trigger field, the data-aware interface engine 114 may insert one or more trigger fields into the data when it converts the first data to second data.

The database server 116 may be configured to select at least a portion of the second data responsive to the one or more trigger fields and load the portion of the second data into a queue table 118 in the database 108. For example, the database server 116 may load into the queue table 118 data that has associated with it trigger data. In the case of a SQL server, the ability to load data into a queue table responsive to trigger data is included in the database server 116. Thus, the queue table 118 may include data corresponding to patient information that is time-sensitive.

The message server may determine the identity or communication coordinates of physicians and/or other caregivers that should receive a message corresponding to data, determine physician or other caregiver preferences for receiving messages, and determine which data read from the queue table 118 should be loaded into the message table 120 addressed to which physicians and/or caregivers. Accordingly, the message server 110 may be configured to output messages according to subscriber preferences. The message server 110 may be configured to output messages addressed to physicians according to physician preferences.

Optionally, the system 101 may send second data messages to subscribers in a way that is adaptive to the locations of individual subscribers. For example, at least some of the plurality of communication devices 122 may be equipped to provide location data. The message server 110 may be configured to cooperate with the web server 112 or another software module to determine subscriber locations. The message server 110 may run a query to determine a location of a patient, and select a subscriber distribution based, at least in part, on the location data from the communication devices 122 and the patient location.

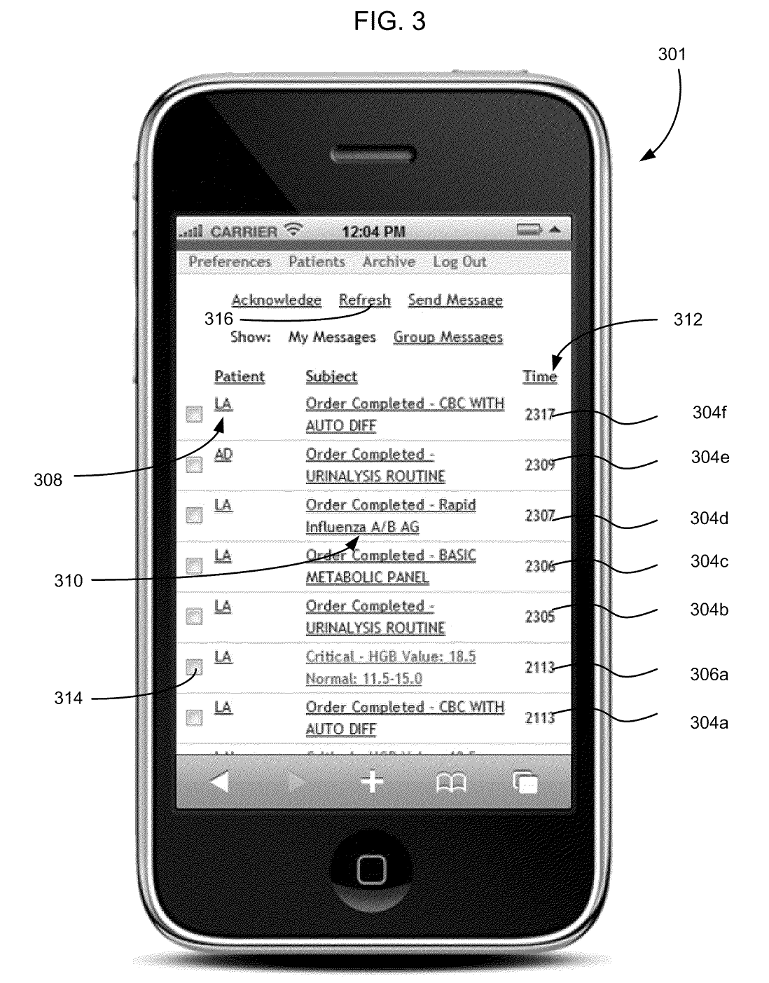

The message server 110 may be further configured to indicate a message priority. This may include adding a field to the second data, or may include formatting the second data according to the urgency or importance included in the second data, for example. The web server 112 may be configured to display messages on communication devices 122 carried by subscribers showing the message priority, which may generally correspond to the importance or urgency of the patient information. For example, as shown in FIG. 3 (and described more fully below), normal priority messages 304a, 304b, 304c, 304d, 304e, and 304f may be displayed in a blue font color, while urgent or high importance messages 306a may be displayed in a red font color, for example.

The web server 112 may be configured to receive logins from subscribers from communication devices 122. The communication devices 122 may, for example, include smart phones. Responsive to a login, the web server 112 may be configured to read messages for display from the message table 120 and selectively transmit the messages to the communication devices 122 corresponding to the subscriber distribution. For example, the web server 112 may be configured to transmit the messages to communication devices via a secure socket layer encrypted interface. The communication devices 122 may thus be configured to receive the messages from the web server 112 via browser interfaces.

FIG. 3 is a depiction of a message display 301 showing event-driven patient-related messages on a communication device 122, according to an embodiment. Normal priority messages 304a, 304b, 304c, 304d, 304e, and 304f may be displayed in a blue font color, for example. Critical value messages (e.g. high importance and/or high urgency messages) 306a may be displayed in a red font color, for example. Thus, at a glance, a physician can quickly see which events demand the quickest attention. Each message 304, 306 may include fields such as patient name 308, an event descriptor 310, and a time received 312. A refresh object 316 allows the user to request a screen refresh, which will add new messages and scroll existing messages. A check box 314 allows the user to select multiple messages simultaneously. The patient names shown on the illustrative screens of FIGS. 3-5 are indicated by initials. In a real world implementation or embodiment, patient names may be substituted for the initials.

An acknowledge object 318 on the screen 301 allows the physician to acknowledge receipt of a message. Referring to FIG. 1, acknowledgement informs the system 101 through the web server 112 that the message has been reviewed by the physician, and that the message should be removed from the display. An acknowledge command removes the message from the list and refreshes the screen. Responsive to acknowledgement, the message server 110 and/or other components of the system 101 may log receipt of the message by transferring the acknowledgement, acknowledgement time, and/or messages from the subscriber. Such logging may be entered into the patient record and/or another table of the database 108, and may be used to document delivery and receipt of the patient information. Referring again to FIG. 3, a send message object 120 allows the physician to send a message to another party via the network 104.

Referring again to FIG. 1, the communication devices 122 may receive the messages and, responsive to user input, may select display options and transmit the display options to the web server 112 via a HTTPS interface. The web server 112 may be configured to receive display options from the communication devices 122, responsively transmit a drill-down query to the database server 116, and display the result of the drill-down query. Alternatively, the web server 112 may relay the display option or other request from the communication devices 122 to the message server 110, and the message server 110 may structure a query for the database server 116.

The message table 120 may include a column that contains a query syntax specific to the type of message currently displayed to the clinician's message board or list of messages (e.g. on a communication device 122). User selection of a “Details” option may cause the message server 110 to drive a drill-down query to be executed by the database server 116, which provides resultant data from the database 108. The drill-down message may be assembled by the message server 110 and output by the web server 112 for presentation back to the communication device 122 as a browser page.

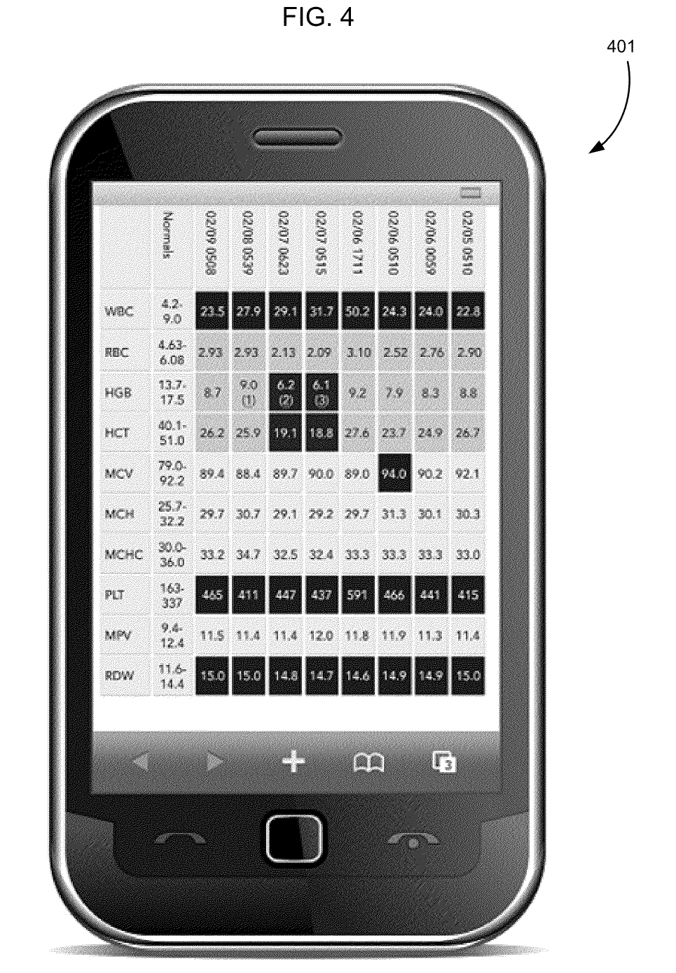

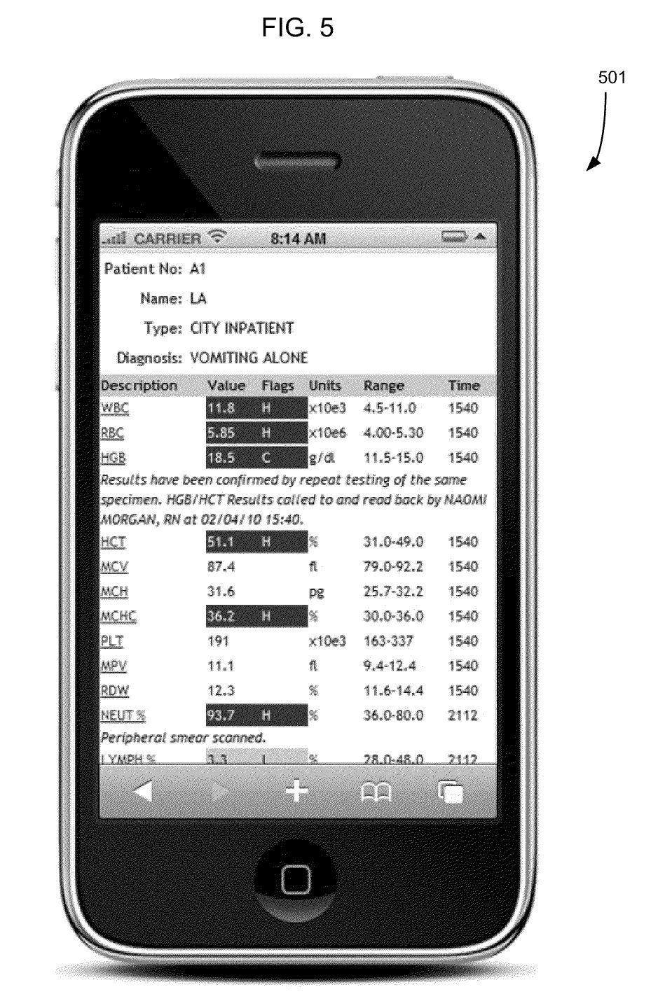

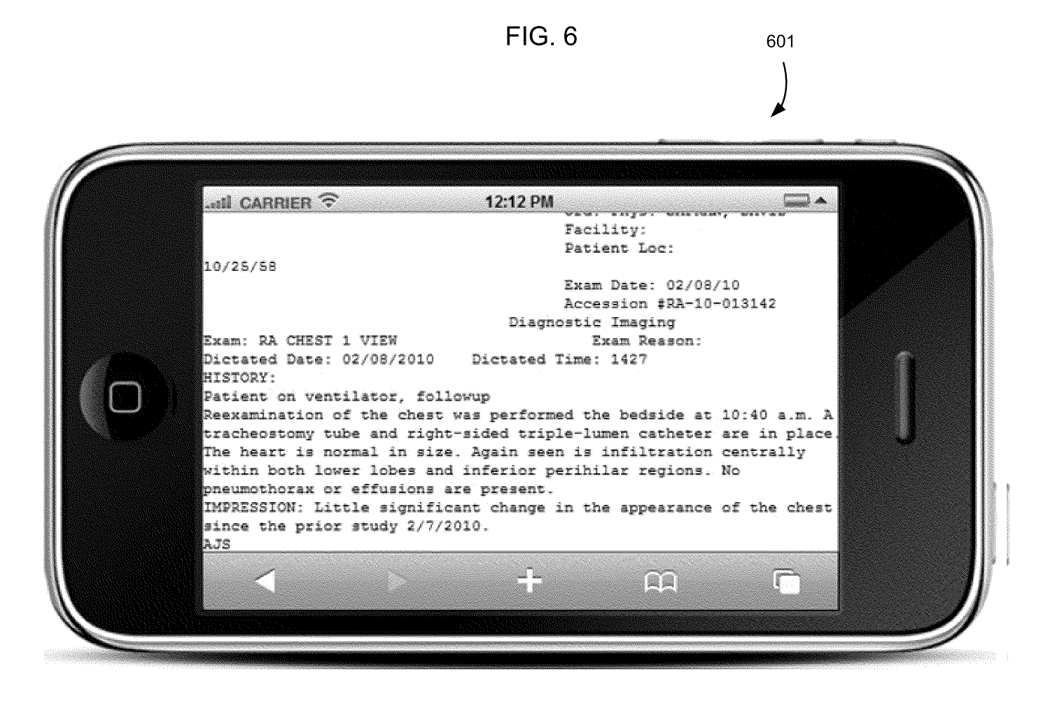

Responsive to processing the communication device 122 request, the web server 110 may display one or more of a grid display of historical data 401 (see FIG. 4), a lab result detail 501 (see FIG. 5), and/or a progress note ready for approval 601 (see FIG. 6). Other drill-down screens such as a text result reports including but not limited to laboratory, radiology or observational documents (not shown), nurse's notes (not shown), or other type of text document (not shown) may similarly be displayed on a communication device 122 responsive to the communication device request. Any patient information that is collected through the data-aware interface engine 114 from first data, or which is otherwise available to queries by the message server 110 may be presented as messages and drill-down supplemental data.

A secure socket layer and browser interface used by the web server 112 and the communication devices 122 can ensure that sensitive patient information remains secure. The remote communication devices 122 typically do not retain the messages when disconnected from the secure socket layer communication interface, thus guarding against loss of patient information.

As an alternative to a browser interface, the remote communication devices 122 may be configured to run one or more applications configured to receive, and optionally retain the messages. At least some of the plurality of communication devices 122 may be equipped to provide location services to the one or more applications. A location received from the location services may provide an input to determining which of the plurality of communication devices 122 should display a message. Optionally, at least some of the plurality of communication devices 122 may be further configured to interrogate local devices (not shown) to receive patient information. For example, such local devices may include one or more of an electronic blood pressure cuff, an electronic thermometer, a fetal monitor, an intravenous pump, an epidural pump, a pulse oximeter, an EKG, and/or an EEG.

According to an embodiment, the web server 112 may be configured to notify a communication device 122 when a new message is ready for the communication device. Thus, in lieu of pushing a new message to the communication device, which may move messages and distract the user, the web server may illuminate or flash a notification object on the screen that otherwise leaves the existing display intact. When a user activates a refresh object on the display (see FIG. 3), the web server 112 receives a refresh command, and responsively displays messages along with one or more new messages received in the message table 120 from the message server 110. Similarly, when a user of a communication device acknowledges a message (see FIG. 3), the web server 112 may be configured to receive acknowledgements to one or more selected displayed messages from the communication device 122 and forward the acknowledgement to the message server 110, which responsively removes the messages from the message table 120. The web server 112 then refreshes the display on the communication device 122 without the acknowledged message. The web server 112 may further be configured to receive messages from communication devices 122 and transfer the received messages to the database 108 (which may then appear on other users' messages lists as they sign in to the application).

As indicated above, a subscriber may have preferences for message display modality that are included in a subscriber preferences table (not shown). A subscriber may have a preference to receive messages via a communication device 126 other than a communication device 122 that may be addressed via the web server 112. In such cases, an outbound interface 124 may be operatively coupled to the message server 110 and configured to selectively output messages to external resources 126. The message server may be configured to selectively output messages to the outbound interface according to the subscriber preferences. For example, the outbound interface may be configured to selectively output messages to external resources 126 as one or more of text messages, pager messages, or voice messages.

An outbound interface 124 may be in the form of one or more software modules configured to run on a computer processor. The computer processor on which the outbound interface 124 runs may be the same computer processor or a different computer processer than that or those on which the message server 110, the web server 112, the data-aware interface engine 114, and/or the database server 116 run.

The outbound interface 124 may be configured to receive outbound messages transferred to the database 108 from communication devices 122, and forward the messages through the interface to one or more external resources. The message server 110 may also be configured to selectively output messages to the outbound interface 124 according to physician preferences, the outbound interface 124 being configured to receive the selectively output messages and forward the output messages to external resources. The external resource may include network 140 resources that output messages to alternative communication devices 126. For example, the outbound messages may include text messages and/or pager messages. Text messages, if sent unencrypted, may omit patient identification information to preserve patient confidentiality. For example, the messages may include a lab result or a message from another practitioner, but omit patient's name. According to an embodiment, text messages may be encrypted, and the plurality of communication devices 126 may be configured to decrypt the text messages, for example, using an application layer process.

The system 101 may further include an administration interface 128 configured to interface with a system administrator.

The system 101 may be configured in a range of physical embodiments. For example, the system 101 may include two or more separate computer resources configured to communicate via one or more IP connections 104. In an embodiment, the system for conveying patient information 101 may be housed in a single housing 130. In this configuration, the apparatus 130 may be provided as an “appliance” that can be connected to a hospital network with a minimum of disruption to existing systems. The system 101 may further include a cache (not shown) configured to receive the first data via the interface and forward the first data via the interface to an external resource. For example, this would allow an apparatus 130 to be assigned existing IP addresses and ports on a network, and so receive all messages transmitted to the existing IP:Port combinations. The existing devices could then be assigned new IP:Port combinations to which the interface 102 of the apparatus 130 forwards the communications. In effect, an apparatus 130 would thus become a network “wedge”.

FIG. 4 is a depiction of a communication device drill-down display 401 showing a grid display of historical data, according to an embodiment. For example, (referring to FIG. 3) if a subscriber indicates a request for drill-down information including a time context for a given message, for example, by touching the message 304c, a drill-down query may be processed as described above, and the screen 401 may be returned to the communication device 122 via its browser interface.

FIG. 5 is a depiction of a communication device drill-down display showing a lab result detail 501, according to an embodiment. For example, (referring to FIG. 3) if a subscriber indicates a request for drill-down information including a time context for a given message, for example, by touching the message 304a, a drill-down query may be processed as described above, and the screen 501 may be returned to the communication device 122 via its browser interface. Optionally, a simple input such as touching an important or urgent message may be processed differently than a simple input such as touching a routine message. Optionally, successive inputs may toggle between displays such as the historical grid display 401 of FIG. 4 and the detailed result display 501 of FIG. 5. Optionally, (referring to FIG. 1) the web server 112 may open a dialog box or other device on the screen of the communication device 122 responsive to a simple input to receive more information about what type of drill-down query is desired. Optionally, the default type of drill-down query may be established in the user preferences table (not shown).

FIG. 6 is a depiction of a communication device drill-down display 601 showing a progress note ready for approval, according to an embodiment. A wide variety of drill-down reports may be generated, as indicated by a small number of examples shown in FIGS. 4-6. Additional types and variations on the reports of FIGS. 4-6 are contemplated and fall within the scope of the description and claims herein.

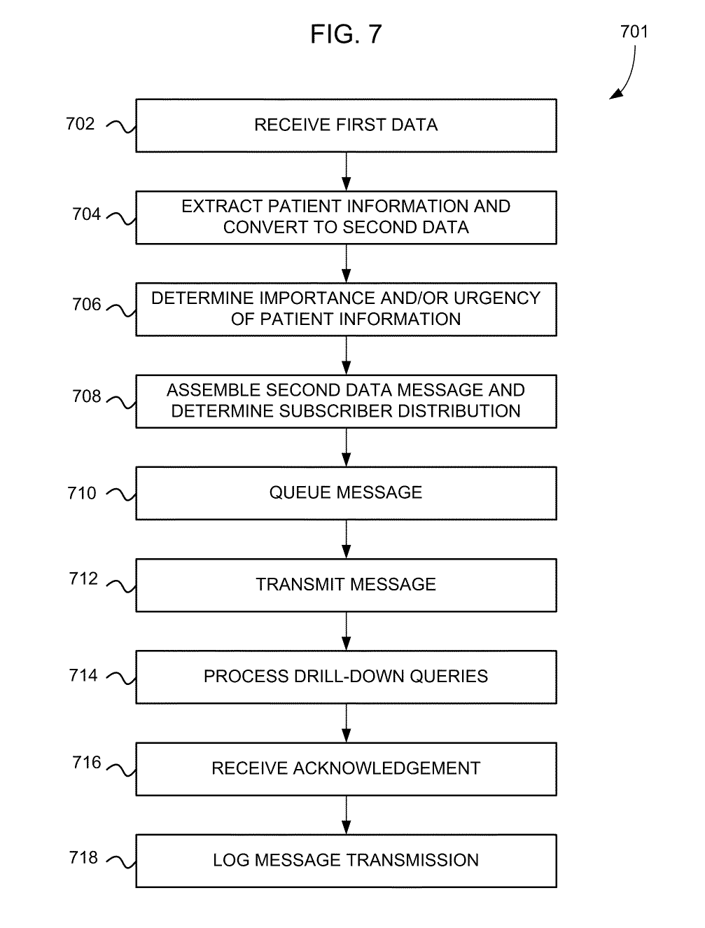

FIG. 7 is a flow chart showing a method 701 for transmitting patient information to communication devices of subscribers, according to an embodiment. Subscribers such as physicians and/or other healthcare providers may receive the patient information via personal communication devices such as smart phones carried by the subscribers, according to embodiments.

Generally speaking, patent information is transmitted within and between healthcare environments as data messages, referred to generically herein as first data, carried by one or more wired or wireless networks. In open environments, i.e., network environments where network resources are configured to communicate with one another via data messages that can be understood by substantially all relevant processes, systems within healthcare environments typically communicate according to Health Level Seven (HL7) messages (also described above). HL7 messages are composed according to HL7 protocols, which are published, open standards recognized by ANSI and ISO. HL7 messages may be compliant with backward-compatible HL7 v2.X standards or, as of the date of this application, the HL7 3.0 standard. In other, typically single-vendor, environments, patient data may be carried in messages composed according to one or more proprietary protocols. According to various embodiments, a first data message may refer to an open protocol data message such as an HL7 data message, or proprietary data messages such as those using vendor-specific protocols.

Each first data message can correspond to an instance of data collection or data input that may be considered to be an event. As will be appreciated, the patient information may be delivered to the subscribers (e.g. individual physicians) responsive to these events. Accordingly, the delivery of patient information may be referred to as event-driven.

Beginning at step 702, first data is received with a network data interface. The first data includes patient information. According to embodiments, the first data may be a HL7 message including patient information. Proceeding to step 704, the patient information can be extracted and/or converted to second data (described more fully elsewhere herein). In some embodiments, step 704 may involve simply parsing an HL7 message to access one or more data fields. In other embodiments, a proprietary data format may be read or may be translated to extract the patient information. In still other embodiments, the first data may include transmitted reference data, and step 704 may include accessing the patient information according to the reference data. For example, reference data may include a network address from which a large patient data set (e.g. a binary large object, or “BLOB”) may be retrieved. Optionally, step 704 can include operating a data interpreter or a diagnostic system, or otherwise perform processing to determine summary data amenable to transmission as a brief message.

Proceeding to step 706, an importance or urgency corresponding to the patient information in the first data message may be determined. Some first data messages may include information that explicitly indicates importance or urgency, and in such cases, step 706 may reduce to reading (and optionally, interpreting) the importance or urgency data.

According to some embodiments, determining an importance or urgency corresponding to the patient information in the first data message in step 706 may include accessing a patient chart and determining an event context corresponding to the first data message. For example, if a patient chart indicates that a patient has a diagnosis corresponding to a respiratory illness, then this can be used to infer a high importance for a first data message delivered from a respiratory therapy department or from a diagnostic apparatus that provides data relevant to the respiratory illness. In contrast, for the same patient, a second event reflected as first data including a nurse's report of administering an antibiotic directed to an infection unrelated to the respiratory illness may be determined from this context to not be of high importance or urgency. But for another patient for whom the infection is a primary reason for care, the second event may be determined to be of high importance (if not urgency), while the first event may be considered routine.

According to some embodiments, determining an importance or urgency corresponding to the patient information in the first data message in step 706 may include comparing a physical or physiological test value in the first data message to one or more predetermined ranges of physical or physiological values. The one or more predetermined ranges of physical or physiological values may be generic or specific to a patient. For example, a heart rate monitor may periodically output a measured patient heart rate as first data. A measured resting heart rate of lower than 50 bpm or higher than 90 bpm may be predetermined to correspond to first data that is important generically. But for a specific patient having a diagnosed heart arrhythmia, a predetermined resting heart rate of over 70 bpm may be determined to be important, and over 80 bpm may be urgent and important. Accordingly, for the specific patient, step 706 may include determining that an event is urgent when the patient information includes a resting heart rate of 82 bpm, even though this rate would only be rated normal for a generic patient. Similar ranges may be contemplated for many measurable physical or physiological attributes. Some examples may include blood count, blood oxygenation, blood pressure, blood sugar, respiration rate, heart rate or arrhythmia, etc.

In some embodiments, step 706 may be considered part of step 704. Steps 704 and 706 may be performed by a data-aware interface engine 114, described above in conjunction with FIG. 1.

Proceeding to step 708, a second data message and subscriber distribution may be assembled. For example, with reference to FIG. 1, the message server 110 may read a queue table 118 in an order according to message urgency or importance, and output each assembled message to the message table 120 in step 710. Step 708 may include data conversion, such as from a database table field structure to a format suitable for transmission via a browser interface. Step 708 may also typically include performing one or more queries to determine information and a subscriber distribution of a message.

Subscribers may, for example, include substantially all caregivers in a given hospital, or may include only some physicians in a given practice. Enrollment of subscribers may be optional or mandatory. The subscriber distribution may typically be determined as a function of the patient information in the first data message. According to some embodiments, the subscriber distribution may also be a function of the importance or urgency determined in step 706. For example, determining the subscriber distribution may include determining a broader subscriber distribution for a higher importance or urgency message.

Step 708 may include accessing subscriber preferences, for example, in a subscriber preferences table held in a database. For example, a primary care physician may register preferences for receiving all messages related to his/her specific patients. In contrast, a hospitalist may register a preference for only receiving urgent messages, but for all patients on campus. Step 708 may also include accessing a current or upcoming work schedule of at least one subscriber. For example, a physician who is on call may be included in the subscriber distribution list, while a physician who is not on call may be omitted from the subscriber distribution list. In some embodiments, the subscriber distribution may switch, at least for non-urgent messages, corresponding to a future work schedule. For example, messages may be sent to an upcoming on-call physician rather than a currently on-call physician during a half hour before the end of a call shift. Such choices may similarly be saved in the subscriber preferences table.

Optionally, determining the subscriber distribution in step 708 may include accessing subscriber logins and selecting an alternative subscriber distribution responsive to a subscriber in the subscriber distribution not logging in to receive the second data. This may be referred to as an alternate subscriber distribution. For example, if a subscriber communication device has a dead battery or the subscriber is otherwise occupied, a patient event could go unnoticed. A timer on a given patient information event may provide an amount of time for a subscriber to view the event. Step 708 may include selecting the alternate subscriber distribution upon expiration of the timer with no login and/or no acknowledgement by a primary (first addressed) subscriber. For example, an urgent event could set a relatively short timer, such as 5 minutes; an important but not urgent event could set a medium timer, such as 1 hour; and a normal priority event could allow a longer timer, such as 4 hours. The particular durations of timers may be set according to the subscriber preferences table, or according to a global preferences table, selectable by a system administrator.

After step 708 (or concurrently, for embodiments where the subscriber distribution is subject to change depending on delivery of messages), the process 701 proceeds to step 710, where the message is queued for delivery to the subscriber distribution. According to an embodiment, step 710 may include associating, with the second data, trigger data corresponding to the importance or urgency corresponding to the patient information. Trigger data may be used by a database server to select a data field (in this case, the second data message including patient information corresponding to the patient information in the first data) for display. In effect, trigger data may be used to select an order of message transmission. Steps 708 and 710 may be performed by a message server 110, as described above in conjunction with FIG. 1.

The process 701 may next proceed to step 712, wherein second data corresponding to the first data message is transmitted to one or more communication devices corresponding to the subscriber distribution. Step 712 may include reading the second data responsive to the trigger data and responsively transmitting the second data to the one or more communication devices corresponding to the subscriber distribution. Optionally, step 712 may include transmitting an indication of the importance or urgency corresponding to the first message to the one or more communication devices.

Transmitting the second data to one or more communication devices corresponding to the subscriber distribution in step 712 may include transmitting the data for display via one or more web browser interfaces. An embodiment using a web browser interface may provide superior securing for patient medical information by keeping the second data message on a remote communication device only while a subscriber is logged in.

Alternatively, determining a subscriber distribution in step 708 may include determining a subscriber preference for information transmission via a medium other than a browser interface. In such a case, step 712 may include transmitting the second data to the at least one subscriber via a medium other than the one or more browser interfaces. For example, the second data may be transmitted to the at least one subscriber via a text message, an electronic page, or a voice message.

Optionally, the process 701 may include step 714, wherein additional patient information may be transmitted to one or more of the communication devices. Step 714 may include receiving, from at least one communication device, a query request for drill-down data related to the second data. On the communication device, the request for drill-down data may be represented by touching the second data message or an icon corresponding to a drill-down request, for example. Responsive to receiving the request from the communication device, a system (for example, the system 101 shown in FIG. 1) may perform a drill-down query corresponding to the query request, and transmit third data corresponding to the drill-down query to the requesting communication device. Optionally, drill-down information may be selected from the communication device by navigating through files and optionally a directory structure represented by a graphical user interface corresponding to the patient chart structure shown in FIG. 2.

Proceeding to step 716, an acknowledgement of the second data and/or a particular instance of the second data may be received from at least one communication device, and the second data removing from display on the communication device.

Proceeding to step 718, transmission of the second data to the one or more communication devices may be logged. Logging the second data may act as proof of transmission in the case of future medical issues and/or may help to ensure that physicians and other caregivers pay proper attention to second data messages.

Not all first data messages need necessarily rise to a nominal level of importance where transmission to one or more subscribers is needed. Depending on subscriber preferences in a given facility, even normal importance patient information in the first data may be suppressed from transmission, perhaps with transmission to communication devices being reserved for important or urgent patient information. In other environments and/or subscriber preferences, normal importance, non-urgent messages may be transmitted, but low importance messages may be suppressed. The process 701 may thus include receiving one or more additional first data messages in step 702, determining an importance or urgency in step 706 that does not warrant transmitting data corresponding to the one or more additional first data messages to any subscriber distribution, and logging a non-transmission of data corresponding to the one or more additional first data messages (not shown).

Some, all, and/or combinations of the method steps shown in the method 701 of FIG. 7 may be embodied as computer executable instructions carried on a non-transitory computer-readable medium. Accordingly, the description above also may apply to a description of the response of one or more computers to the instructions carried by the non-transitory computer-readable medium.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system for conveying patient information, comprising:
a data interface configured to receive first data messages including patient information;
a data-aware interface engine operatively coupled to the data interface and configured to extract the patient information from the first data messages; and
a message server operatively coupled to the data-aware interface engine and configured to selectively output second data messages carrying at least a portion of the patient information or an indication of the patient information to a plurality of communication devices.

2. The system for conveying patient information of claim 1, wherein the data interface is configured to receive the first data messages from a plurality of sources.

3. The system for conveying patient information of claim 1, wherein patient information includes one or more of admission information, patient consents, physicians' orders, an order allowed by law by a licensed practitioner, physicians' progress notes, physicians' comments, laboratory results, pharmacy medication logs, nursing notes, nursing assessments, nursing care plans, respiratory therapy progress notes, dietary notes, and nurses' station messages.

4. The system for conveying patient information of claim 1, wherein the first data messages include Health Level Seven (HL7) messages.

5. The system for conveying patient information of claim 1, further comprising:
one or more databases operatively coupled to the data-aware interface engine and the message server;
wherein the data-aware interface engine is further configured to output the extracted patient information to the one or more databases as second data for retrieval by the message server.

6. The system for conveying patient information of claim 5, wherein the data-aware interface engine is configured to associate with the second data one or more trigger fields selected to cause the message server to output the second data messages responsive to an importance or urgency of the patient information.

7. The system for conveying patient information of claim 1, wherein the data-aware interface engine is configured to select messages for output by the message server as a function of importance or urgency of the patient information.

8. The system for conveying patient information of claim 7, wherein the data-aware interface engine is configured to determine the importance or urgency of the patient information by extracting one or more data fields from the first data messages, wherein the one or more data fields include one or more explicit indications of importance or urgency of the patient information.

9. The system for conveying patient information of claim 7, wherein the data-aware interface engine is configured to determine the importance or urgency of the patient information by accessing a patient chart and determining an event context corresponding to the patient information in the first data message.

10. The system for conveying patient information of claim 7, wherein the data-aware interface engine is configured to determine the importance or urgency of the patient information by comparing a physical or physiological test value in the first data message to one or more predetermined ranges of physical or physiological values.

11. The system for conveying patient information of claim 1, further comprising:
one or more databases operatively coupled to the data-aware interface engine and the message server;
wherein the message server is further configured to
read, from the one or more databases, second data saved by the data-aware interface engine, the second data including the extracted patient information;
perform one or more queries to determine additional information related to the patient information; and
assemble an indication of the patent information or at least portions of the patient information into the second data messages.

12. The system for conveying patient information of claim 11, wherein performing one or more queries includes performing one or more XML Path Language (XPath) queries.

13. The system for conveying patient information of claim 11, wherein performing one or more queries includes performing one or more queries to determine a subscriber distribution.

14. The system for conveying patient information of claim 13, wherein performing one or more queries to determine a subscriber distribution includes querying a patient record and querying subscriber preferences.

15. The system for conveying patient information of claim 13, wherein the message server is further configured to explicitly populate the second data messages with subscribers included in the message distribution.

16. The system for conveying patient information of claim 1, further comprising:
a web server operatively coupled to the message server and configured to output the second data messages for presentation by browser interfaces in the plurality of communication devices.

17. The system for conveying patient information of claim 16, wherein the web server is further configured to receive acknowledgement data from the plurality of communication devices; and
wherein the message server is further configured to log the acknowledgements in one or more databases.

18. The system for conveying patient information of claim 16, wherein the web server is further configured to receive a request for drill-down data from a communication device and pass the request for drill-down data to the message server;
wherein the message server is further configured to receive the request for drill-down data, perform one or more drill-down queries, and assemble a drill-down message including the requested drill-down data; and
wherein the web server is further configured to output the drill-down message to the communication device.

19. The system for conveying patient information of claim 1, wherein the data-aware interface engine is configured to output second data including trigger data, and wherein the message server is configured to receive the second data responsive to a trigger function determined by the trigger data.

20. The system for conveying patient information of claim 1, further comprising a database operatively coupled to the data-aware interface engine and the message server;
wherein the database includes a queue table configured to receive second data including the patient information output by the data-aware interface engine; and
wherein the message server is configured to receive the second data from the data-aware interface engine by reading the queue table.

21. The system for conveying patient information of claim 1, further comprising:
a web server; and
a database operatively coupled to the message server and the web server, and including a message table; and
wherein the message server is configured to output the second data messages to the message table and the web server is configured to read the second data messages from the message table.

22. The system for conveying patient information of claim 21, wherein the web server is configured to receive logins from the plurality of communication devices and output, to each respective communication device, second data messages for which the communication device is selected for subscriber distribution.

23. The system for conveying patient information of claim 1, wherein the message server is further configured to indicate a second data message priority.

24. The system for conveying patient information of claim 1, wherein the message server is configured to output messages according to subscriber preferences.

25-31. (canceled)

32. The system for conveying patient information of claim 1, further comprising:
a web server operatively coupled to the message server and configured to output messages corresponding to a particular communication device according to a display list; and
wherein the web server is configured to receive acknowledgements to one or more selected displayed messages from the particular communication device and responsively remove the messages from the display list.

33. The system for conveying patient information of claim 1, further comprising:
a web server operatively coupled to the message server and configured to receive a refresh command from a communication device and responsively display one or more new messages received from the message server.

34. The system for conveying patient information of claim 1, further comprising:
a web server operatively coupled to the message server and configured to receive messages from communication devices and transfer the received messages to a database.

35. The system for conveying patient information of claim 1, further comprising:
an outbound interface operatively coupled to the message server and configured to selectively output messages to external resources;
wherein the message server is further configured to selectively output messages to the outbound interface according to subscriber preferences.

36. The system for conveying patient information of claim 35, wherein the outbound interface is configured to selectively output messages as one or more of text messages, pager messages, or voice messages.

37. The system for conveying patient information of claim 1, wherein the data-aware interface engine and the message server include two or more separate computer resources configured to communicate via one or more Internet Protocol (IP) connections.

38. The system for conveying patient information of claim 1, wherein the data-aware interface engine and the message server are disposed in a single housing.

39. The system for conveying patient information of claim 1, wherein the data-aware interface engine and the message server each include a software module configured to run on the same computer processor.

40. The system for conveying patient information of claim 1, wherein at least one of the plurality of communication devices includes a smart phone.

41. A method for conveying patient information, comprising:
receiving, with a network data interface, a first data message including patient information;
determining, with a computer processor, an importance or urgency corresponding to the patient information in the first data message;
determining, with the computer processor, a subscriber distribution corresponding to the patient information in the first data message; and
transmitting second data corresponding to the first data message to one or more communication devices corresponding to the subscriber distribution.

42. The method for conveying patient information of claim 41, wherein the first data message is a Health Level Seven (HL7) message.

43. The method for conveying patient information of claim 41, further comprising:
extracting the patient information from the first data message.

44. The method for conveying patient information of claim 41, wherein determining the importance or urgency corresponding to the patient information in the first data message includes reading a data field in the first data message that explicitly indicates the importance or urgency.

45. The method for conveying patient information of claim 41, wherein determining an importance or urgency corresponding to the patient information in the first data message includes accessing a patient chart and determining an event context corresponding to the first data message.

46. The method for conveying patient information of claim 41, wherein determining an importance or urgency corresponding to the patient information in the first data message includes comparing a physical or physiological test value in the first data message to one or more predetermined ranges of physical or physiological values.

47. The method for conveying patient information of claim 41, wherein determining the subscriber distribution includes accessing a patient chart.

48. The method for conveying patient information of claim 41, wherein determining the subscriber distribution includes accessing subscriber preferences.

49. The method for conveying patient information of claim 41, wherein determining the subscriber distribution includes accessing a current or upcoming work schedule of at least one subscriber.

50. (canceled)

51. The method for conveying patient information of claim 41, wherein determining the subscriber distribution includes determining the subscriber distribution as a function of the importance or urgency.

52. (canceled)

53. The method for conveying patient information of claim 41, further comprising:
converting the first data message to the second data; and
associating, with the second data, trigger data corresponding to the importance or urgency corresponding to the patient information.

54. The method for conveying patient information of claim 53, further comprising:
reading the second data responsive to the trigger data prior to transmitting the second data to the one or more communication devices corresponding to the subscriber distribution.

55. The method for conveying patient information of claim 41, further comprising:
transmitting an indication of the importance or urgency corresponding to the first message to the one or more communication devices.

56. The method for conveying patient information of claim 41, further comprising:
logging the transmission of the second data to the one or more communication devices.

57. (canceled)

58. The method for conveying patient information of claim 41, wherein transmitting the second data to one or more communication devices corresponding to the subscriber distribution includes transmitting the data for display via one or more web browser interfaces.

59. The method for conveying patient information of claim 41, wherein determining a subscriber distribution corresponding to the patient information in the first data message and the importance or urgency includes determining at least one subscriber preference for information transmission via a medium other than a browser interface; and
wherein transmitting the second data to one or more communication devices corresponding to the subscriber distribution includes transmitting the second data to the at least one subscriber via the medium other than the one or more browser interfaces.

60. The method for conveying patient information of claim 59, wherein transmitting the data to the at least one subscriber via the medium other than the browser interface includes transmitting the data to the at least one subscriber via a text message, an electronic page, or a voice message.

61. The method for conveying patient information of claim 41, further comprising:
receiving, from at least one communication device, a query request for drill-down data related to the second data;
performing a drill-down query corresponding to the query request; and
transmitting, to the at least one communication device, third data corresponding to the drill-down query.

62. The method for conveying patient information of claim 41, further comprising:
receiving, from at least one communication device, an acknowledgement of the second data; and
removing the second data from display on the at least one communication device.

63. The method for conveying patient information of claim 41, wherein the one or more communication devices comprise one or more smart phones.

64. A non-transitory computer-readable medium carrying computer-executable instructions configured to cause a computer to execute the steps, comprising:
receiving, with a network data interface, a first data message including patient information;
determining, with a computer processor, an importance or urgency corresponding to the patient information in the first data message;
determining, with the computer processor, a subscriber distribution corresponding to the patient information in the first data message; and
transmitting second data corresponding to the first data message to one or more communication devices corresponding to the subscriber distribution.

65. The non-transitory computer-readable medium carrying computer-executable instructions of claim 64, wherein the first data message is a Health Level Seven (HL7) message.

66. The non-transitory computer-readable medium carrying computer-executable instructions s of claim 64, wherein the steps further comprise:
extracting the patient information from the first data message.

67. The non-transitory computer-readable medium carrying computer-executable instructions of claim 64, wherein determining the importance or urgency corresponding to the patient information in the first data message includes reading a data field in the first data message that explicitly indicates the importance or urgency.

68-75. (canceled)

76. The non-transitory computer-readable medium carrying computer-executable instructions of claim 64, wherein the steps further comprise:
converting the first data message to the second data; and
associating, with the second data, trigger data corresponding to the importance or urgency corresponding to the patient information.

77. The non-transitory computer-readable medium carrying computer-executable instructions of claim 76, wherein the steps further comprise:
reading the second data responsive to the trigger data prior to transmitting the second data to the one or more communication devices corresponding to the subscriber distribution.

78. The non-transitory computer-readable medium carrying computer-executable instructions of claim 64, wherein the steps further comprise:
transmitting an indication of the importance or urgency corresponding to the first message to the one or more communication devices.

79-80. (canceled)

81. The non-transitory computer-readable medium carrying computer-executable instructions of claim 64, wherein transmitting the second data to one or more communication devices corresponding to the subscriber distribution includes transmitting the data for display via one or more web browser interfaces.

82-83. (canceled)

84. The non-transitory computer-readable medium carrying computer-executable instructions of claim 64, wherein the steps further comprise:
receiving, from at least one communication device, a query request for drill-down data related to the second data;
performing a drill-down query corresponding to the query request; and
transmitting, to the at least one communication device, third data corresponding to the drill-down query.

85-86. (canceled)
